(19) United States
(12) Patent Application Publication
(10) Pub. No.: US 2015/0037720 A1
(43) Pub. Date: Feb. 5, 2015

(54) MAGNETIC TONER

(71) Applicant: CANON KABUSHIKI KAISHA, Tokyo (JP)

(72) Inventors: Shohei Tsuda, Suntou-gun (JP); Yojiro Hotta, Mishima-shi (JP); Kouji Nishikawa, Susono-shi (JP); Shotaro Nomura, Suntou-gun (JP); Katsuhisa Yamazaki, Numazu-shi (JP); Masami Fujimoto, Suntou-gun (JP); Takayuki Itakura, Mishima-shi (JP)

(21) Appl. No.: 14/446,112

(22) Filed: Jul. 29, 2014

(30) Foreign Application Priority Data
Jul. 31, 2013 (JP) 2013-159303

(51) Int. Cl. G03G 9/083

(52) U.S. Cl. CPC G03G 9/0838; G03G 9/0831
USPC 430/108.3

(57) ABSTRACT

Provided is magnetic toner capable of favorably maintain fluidity of the magnetic toner in a developing unit even after a large number of image formation. The magnetic toner to which an external additive that has 1) a number average particle diameter of 70 or more and 200 or less, 2) a shape factor SF-1 of 100 or more and 250 or less, and 3) a shape factor SF-2 of 105 or more and 250 or less, is added, and a covering rate by silica on the surfaces of toner particles is 40.0% or more and 70.0% or less, and the magnetic toner has specific fluidity.

### BACKGROUND OF THE INVENTION

1. Field of the Invention

The present invention relates to magnetic toner used in a method for forming an image and a toner jet (hereinafter, may be referred to as “magnetic toner”) that actualize electrophotographic image and an electrostatic charge image.

2. Description of the Related Art

Conventionally, magnetic toners used for image formation by a magnetic one-component jumping developing method have been required to have high fluidity for stable supply to a developing sleeve, image density, and image stabilization. As an external additive that provides the fluidity, an external additive having a small particle diameter has been often used.

Meanwhile, in recent years, higher speed and longer lifetime have been required for copying machines, printers, and the like, and thus the magnetic toners need to be durable for use for a long period of time than ever.

Considering such future realization of high speed and long lifetime, it is anticipated that a share will be loaded on the magnetic toners than ever between the developing sleeve and a toner regulating blade. Therefore, it is expected that embedding of the external additive having a small particle diameter, which adheres to a surface of the magnetic toner, is further facilitated, and a function as the external additive will not be exerted. As a result, the image density cannot be stably maintained through endurance.

Further, after a printer is used for a long period of time, and when a power supply of the printer is turned off once and is turned on again after being left for a long period of time, additive circulation with an agitating blade in the developing unit becomes unstable, and image defect of the first image after turning on again, for example, density nonuniformity of a solid black image due to developing sleeve coating failure is concerned.

Japanese Patent No. 03684074 discusses an example that suppresses embedding of an external additive having a small particle diameter in a toner surface by adding deformed silica to non-magnetic two-component developer toner. However, when the deformed silica is applied to the magnetic toner, rubbing between the developing sleeve and the toner regulating blade that provide charging becomes extremely stronger than that in two-component developing. Therefore, cracking and chipping of the external additive itself occur, and the particle diameter is decreased in size. Accordingly, the external additive is embedded in the toner, and failure may occur in the durability and the additive circulation.

Japanese Patent Application Laid-Open No. 2007-279702 discusses an example in which high spacer effect is expected in nonmagnetic toner, and embedding of the external additive and rolling on the toner surface due to the rubbing between the developers are suppressed when nonspherical amorphous silica having a large particle diameter is externally added to obtain a two-component developer. However, when the external additive is applied to the magnetic one-component jumping method, rubbing between the developing sleeve and the toner regulating blade is stronger than that of between the two-component developers. Therefore, isolation of the external additive and packing between toners occur, and issues, such as white streak and density nonuniformity, may be caused.

Japanese Patent No. 4984619 discusses an example in which, when a basic fluidity energy amount of a powder rheometer (hereinafter, abbreviated as FT-4) is controlled in magnetic toner that uses a monodispersed spherical external additive having a large particle diameter and an inorganic fine particles having a small particle diameter together, conveying performance when the toner is supplied to a developing unit becomes favorable. However, the monodispersed spherical external additive rolls on a surface of the magnetic toner and is isolated due to rubbing between a developing sleeve and a toner regulating blade in the developing unit after conveyance, which may incur a contamination of a charging member or deterioration of developability during endurance.

In view of the foregoing, there is room for improvement to establish both endurance stability and image quality stability in a magnetic one-component jumping developing method.

### SUMMARY OF THE INVENTION

The present invention is directed to magnetic toner that can overcome the above problems.

The present invention is directed to a magnetic toner having favorable endurance stability in a magnetic one-component jumping developing method. Further, the present invention is directed to magnetic toner capable of favorably maintaining fluidity of the magnetic toner in a developing unit even after formation of a large number of images.

According to an aspect of the present invention, magnetic toner includes magnetic toner particles, each of which contains a binder resin and a magnetic material, and a first external additive, in which

the first external additive

1) is silica fine particles or resin composition-silica composite particles,
2) has a number average particle diameter of 70 or more and 200 nm or less,
3) has a shape factor SF-1 of 100 or more and 250 or less, and
4) has a shape factor SF-2 of 105 or more and 250 or less, and

a covering rate of a surfaces of the magnetic toner particles by silica measured by ESCA is 40.0% or more and 70.0% or less, and

total energy calculated from a rotation torque and a vertical load is 80.0 mJ or more and 140.0 mJ or less, the rotation torque and the vertical load being obtained by the following steps of:

putting the magnetic toner in the measurement container;

compressing the magnetic toner put in the measurement container with a load of 5.8 kPa, and forming a compressed toner layer; and

advancing a propeller type blade into the compressed toner layer at a constant speed vertically with respect to the surface of the compressed toner layer, the propeller type blade rotating at an outermost edge's peripheral speed of 100 mm/sec.

Further features of the present invention will become apparent from the following description of exemplary embodiments.

### DESCRIPTION OF THE EMBODIMENTS

Various exemplary embodiments, features, and aspects of the invention will be described in detail below with reference to the drawings.

Assuming realization of high speed and long lifetime of a printer, endurance stability and image quality stability than ever are required. As a result of examination by the inventors of the present invention, it has been found out that the endurance stability and the image quality stability in the magnetic one-component jumping developing method are largely correlated with toner degradation. As a result of further examination, it has been found out that the toner degradation in the magnetic one-component jumping development largely depends on embedding of an external additive having a small particle diameter caused by rubbing between a developing sleeve and a toner regulating blade in a developing unit and rubbing between toners in additive circulation with an agitating blade in the developing unit. As described above, the deteriorated toner causes deterioration of image density and circulation failure when the printer is started again after being left because of the deterioration of charging characteristics and deterioration of fluidity occur.

Therefore, assuming realization of the high speed and the long lifetime of printers and the like in the future, it is important to suppress the toner deterioration due to the rubbing between the developing sleeve and the toner regulating blade, and the rubbing between magnetic toners in additive circulation with an agitating blade in the developing unit.

An example of a technique for suppressing the degradation includes a large amount of addition of the external additive having a small particle diameter, represented by silica, for example. However, while the technique provides life prolongation to the endurance stability, embedding of the external additive in the surface of the magnetic toner cannot be avoided in long-term use. As a result, the fluidity is deteriorated, packing of magnetic toner powder layers in the developing unit is caused, which exerts influence on the image quality.

Alternatively, to secure the stable fluidity, a technique for using an external additive having a large particle diameter that may serve as a spacer between the magnetic toners together with the external additive having a small particle diameter can be considered. However, when spherical silica produced by a wet sol-gel method is applied as the external additive having a large particle diameter, it is difficult to cause the external additive to adhere to the magnetic toner surface because of its spherical shape, and the external additive is isolated from the magnetic toner, and does not sufficiently function as the spacer through endurance. As a result, the charging characteristics are deteriorated, and image failure is caused, and further, the isolated external additive may contaminate a charging member in the developing unit. Further, when the external additive having a large particle diameter rolls on the magnetic toner surface, the external additive having a small particle diameter used together is embedded in the magnetic toner surface accordingly, the fluidity is deteriorated, and the packing of the magnetic toner powder layers may be caused.

To solve the problems, deformed silica has been used as the external additive that exerts sufficient spacer effect through endurance. However, cracking and chipping of the external additive were caused due to the rubbing between the developing sleeve and the toner regulating blade, and embedding in the toner surface could not be avoided.

As described above, in the existing situation, it has been difficult to suppress deterioration of charging characteristics and the deterioration of the fluidity caused by the toner degradation due to the rubbing between the developing sleeve and the toner regulating blade in the developing unit, and the rubbing between the toners in the agitating blade in the developing unit, at the same time.

Therefore, the inventors of the present invention thought an external additive having a large particle diameter, which exerts sufficient spacer effect during endurance, and in which cracking and chipping do not occur even by large stress, such as rubbing between a developing sleeve and a toner regulating blade, is important. That is, the inventors thought the deterioration of the charging characteristics and the deterioration of the fluidity can be suppressed at the same time during endurance by an external additive that is not embedded in a magnetic toner surface, does not roll, and does not crack and chip, due to rubbing in the developing unit.

As a result of diligent examination, the inventors of the present invention have found out that the following items need to be satisfied in order to obtain suppression of embedding of an external additive in magnetic toner particles, exertion of sufficient effect as a spacer by the external additive without rolling on the magnetic toner surface through endurance, and stable fluidity as toner.

Specifically, it is important that

(1) an external additive that is silica fine particles or resin composition-silica composite particles, and has a specific particle diameter and a shape factor, is added,
(2) magnetic toner has a controlled silica covering rate, and
(3) energy when a compressed magnetic toner powder layer is loosened by a propeller type blade falls within a certain range.

First, a first external additive used in an exemplary embodiment of the present invention has a number average particle diameter of 70 nm or more and 200 nm or less.

If the number average particle diameter is less than 70 nm, embedding of the external additive due to rubbing between the developing sleeve and the toner regulating blade in the magnetic one-component jumping developing method easily occurs. As a result, the packed magnetic toner cannot be easily loosened, and white streak or density nonuniformity is seen in a solid black image, accordingly. On the other hand, if the number average particle diameter is 200 nm or more, the effect as a spacer is exerted. However, in later endurance, movement of the external additive to a magnetic toner recessed portion, and isolation of the external additive from the magnetic toner surface occur together, and a contamination to a charging member, and white streak or density nonuniformity in the solid black image are seen. Further, a specific surface area of the external additive becomes smaller, effective charge imparting is not exerted, and the developability is deteriorated.

Further, in an exemplary embodiment of the present invention, a shape factor SF-1 of the first external additive is 100 or more and 250 or less, and SF-2 is 105 or more and 250 or less. Further, it is more favorable that SF-1 is 140 or more and 250 or less, and SF-2 is 120 or more and 250 or less.

If the shape factor SF-2 of the first external additive is less than 105, the shape of silica becomes closer to a spherical shape, and movement of the external additive to the toner recessed portion and the isolation becomes remarkable similarly to the above, and a contamination to the charging member, and white streak or density nonuniformity in the solid black image are seen.

In contrast, if SF-1 exceeds 250, a long diameter of the external additive tends to be larger, the fluidity is deteriorated, and the deterioration of the image density and the density nonuniformity occur. If SF-2 exceeds 250, the degree of unevenness becomes even higher, cracking of coalesced particles due to endurance easily occurs, the particle diameter is decreased in size, and the embedding occurs.

Further, in an exemplary embodiment of the present invention, a covering rate of surfaces of the magnetic toner particles by silica is 40.0% or more and 70.0% or less.

If the silica covering rate is less than 40.0%, charging failure occurs and aggregation between toners occur accordingly, and the developability is substantially deteriorated. In contrast, if the silica covering rate is higher than 70.0%, fixing is impeded.

Further, in an exemplary embodiment of the present invention, total energy calculated from a rotation torque and a vertical load is 80.0 mJ or more and 140.0 mJ or less. The rotation torque and the vertical load are obtained by the following steps of:

putting the magnetic toner in the measurement container;

compressing the magnetic toner put in the measurement container with a load of 5.8 kPa, and forming a compressed toner layer; and

advancing a propeller type blade into the compressed toner layer at a constant speed vertically with respect to the surface of the compressed toner layer, the propeller type blade rotating at an outermost edge's peripheral speed of 100 mm/sec. The inventors of the present invention consider the total energy has correlation with force applied to the toner by rubbing between the developing sleeve and the toner regulating blade, and force applied to the toner when the agitating blade of the developing unit begins to rotate.

If the total energy is less than 80.0 mJ, aggregation among the magnetic toners occurs, and initial developability is deteriorated, which become a cause of the deterioration of the density of the solid black image. Accordingly, white streak or density nonuniformity is seen in the solid black image at reboot after the printer is stopped.

If the total energy exceeds 140.0 mJ, the initial developability is favorable, but packing occurs in the developing unit due to endurance, and it becomes difficult to easily loosen the toner with the agitating blade in the developing unit. As a result, the density nonuniformity or white streak is seen in the solid black image when the printer is started again after stopped.

As described above, by use of the external additive that satisfies all of the above characteristics, magnetic toner that does not cause the external additive to be embedded in the magnetic toner, does not cause the external additive to roll on the magnetic toner surface, and cause the external additive to exert the sufficient effect as a spacer, through endurance, and has stable fluidity in any use, can be obtained.

Examples of the silica that is the first external additive used in an exemplary embodiment of the present invention include wet silica prepared by a precipitation method, a sol-gel method, or the like, and dry silica prepared by a deflagration method, a fumed method, or the like. However, the dry silica is favorable because of easy control of the shape of the external additive, which is one of the characteristics of the present invention.

The material of the dry silica is a silicon-halogen compound, and the like.

As the silicon-halogen compound, silicon tetrachloride is used. Further, silane-based compound, such as methyltrichlorosilane, or trichlorosilane, alone, or a mixed state of silicon tetrachloride and a silane-based compound can also be used as a material.

After the material is vaporized, the material reacts with water generated as an intermediate in oxyhydrogen flame by a flame hydrolysis reaction, and objective silica is obtained.

For example, a thermal decomposition oxidation reaction in oxygen and hydrogen of a silicon tetrachloride gas is used, and the reaction formula is as follows:

SiCl₄+2H₂+O₂→SiO₂+4HCl

Hereinafter, a method for manufacturing dry nonspherical silica used in an exemplary embodiment of the present invention will be described.

An oxygen gas is supplied to a burner, the ignition burner is ignited, a hydrogen gas is then supplied to the burner and a flame is formed. Silicon tetrachloride that is the material is put into the flame and is gasified. Next, a flame hydrolysis reaction is performed in a condition illustrated in Table 1, and generated silica powder is collected.

The average particle diameter and the shape can be arbitrarily adjusted by appropriate changing of a silicon tetrachloride flow rate, an oxygen gas supply flow rate, a hydrogen gas supply flow rate, and an in-frame retaining time of silica.

Thereafter, the obtained silica powder is transferred to an electric furnace, spread in a thin layer manner, and is then subjected to heat processing and sintered.

The coalescence strength is enhanced, and the external additive becomes durable for rubbing between the developing sleeve and the toner regulating blade in the developing unit by applying of the heat processing, which are characteristics of the dry nonspherical silica used in an exemplary embodiment of the present invention.

Further, it is also favorable that the external additive is resin composition-silica composite particles. The resin composition-silica composite particles used in an exemplary embodiment of the present invention will be described in detail.

The resin composition-silica composite particles used in an exemplary embodiment of the present invention favorably has a structure in which a resin particle is used as a mother particle, and a silica fine particle exist on a surface of the resin particle.

An advantage of composition is that the shape can be controlled to some extent. The shape of the resin composition-silica composite particle can be controlled according to a compounding ratio of the resin composition and the silica fine particles, a particle diameter of the silica fine particle, and whether the silica fine particles are to be hydrophilic or hydrophobic.

An example of a technique for making a composite using the resin composition and the silica fine particles is the method discussed in WO 2013/063291. Alternatively, examples of a method to manufacture the resin composition-silica composite fine particles can be performed by: i) injecting the silica fine particles into organic particles afterward, and ii) dispersing a resin dissolved in a solvent in a dispersion medium in which the silica fine particles are dispersed, granulating particles, and then removing the solvent.

Examples of organic components used for the resin composition-silica composite particles include: styrene monomers such as styrene, o-methylstyrene, m-methylstyrene, p-methylstyrene, p-methoxystyrene, and p-ethylstyrene; acrylic esters such as methyl acrylate, ethyl acrylate, n-butyl acrylate, isobutyl acrylate, n-propyl acrylate, n-octyl acrylate, dodecyl acrylate, 2-ethylhexyl acrylate, stearyl acrylate, 2-chloroethyl acrylate, and phenyl acrylate; methacrylic esters such as methyl methacrylate, ethyl methacrylate, n-propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, and diethylaminoethyl methacrylate; and other monomers such as acrylonitrile, methacrylonitrile and acrylamides. These monomers can be used alone or can be mixed and used. As the silica used for the resin composition-silica composite particles, both of dry silica prepared by a deflagration method, a fumed method, or the like, and wet silica prepared by a sol-gel method are applicable.

In an exemplary embodiment of the present invention, the nonspherical dry silica is more favorable than the resin composition-silica composite particles. This is because shape control of the nonspherical dry silica is easier, and suppression of a contamination of a charging member caused by isolation of the external additive from the magnetic toner surface and of resin fusion on a drum is easier. Especially, the silica composite particles in which a plurality of silica particles is coalesced are favorable.

Further, as the first external additive used in an exemplary embodiment of the present invention, processed silica subjected to surface treatment, such as hydrophobic processing or silicone oil processing, may be used.

As a hydrophobic method, an organic silicon compound, which reacts with or physically absorbs silica, is used to chemically process the silica. A favorable method is to process silica generated by vapor phase oxidation of a silicon halogen compound with an organic silicon compound.

Further, examples of such an organic silicon compound are as follows: Hexamethyldisilazane, trimethylsilane, trimethylchlorosilane, trimethylethoxysilane, dimethyldichlorosilane, methyltrichlorosilane, allyldimethylchlorosilane, allylphenyldichlorosilane, and benzyldimethylchlorosilane.

Further, examples include: bromomethyldimethylchlorosilane, α-chloroethyltrichlorosilane, β-chloroethyltrichlorosilane, chloromethyldimethylchlorosilane, triorganosilyl mercaptan, trimethylsilyl mercaptan, and triorganosilyl acrylate.

Still further, examples include: vinyldimethylacetoxysilane, dimethyldiethoxysilane, dimethyldimethoxysilane, diphenyldiethoxysilane, and 1-hexamethyldisiloxane.

Still further, examples include: 1,3-divinyltetramethyldisiloxane, 1,3-diphenyltetramethyldisiloxane, and a dimethylpolysiloxane having 2 to 12 siloxane units per molecule and containing a hydroxyl group bonded to one Si atom in a unit positioned at the end.

These examples are used alone, or as a mixture of two or more types.

Further, as a favorable silicone oil in the silicone oil processing silica, a silicone oil in which the viscosity at 25° C. is 30 mm²/s or more and 1,000 mm²/s or less, is used.

For example, examples of the silicone oil include: dimethylsilicone oil, methylphenylsilicone oil, α-methylstyrene modified silicone oil, chlorophenylsilicone oil, and fluorine modified silicone oil.

Examples of a method for the silicone oil processing are as follows:

a method for directly mixing silica processed with a silane coupling agent and a silicone oil using a mixer like a Henschel mixer,
a method for spraying a silicone oil on silica that is a base, and a method for dissolving or dispersing a silicone oil in an appropriate solvent, adding and mixing silica, and removing the solvent.

It is more favorable that the silicone oil processing silica is heated to a temperature of 200° C. or more (more favorably, 250° C. or more) in an inert gas after the processing of the silicone oil, and coating on a surface is stabilized.

An example of a favorable silane coupling agent includes hexamethyldisilazane (HMDS).

These first external additives are more favorable to have the first external additive of 1.0 parts by mass or more and 3.0 parts by mass or less, to the toner particles of 100.0 parts by mass.

Further, in the toner of an exemplary embodiment of the present invention, as a second external additive, it is favorable to use inorganic fine powder having high fluidity imparting capability to the toner particle surfaces, and the number average particle diameter of primary particles of 5 nm or more and 30 nm or less.

For example, silica fine powder can be used as the second external additive. Examples of commercially available fine silica powders include: AEROSIL 130, 200, 300, 380, TT600, MOX170, MOX80, COK84 (Aerosil Japan, Ltd.); Ca—O-SiL M-5, MS-7, MS-75, HS-5, EH-5 (Cabot Co.); Wacker HDK N20, V15, N20E, T30, T40 (Wacker-CHEMIE GMBH); D-C Fine Silica (Dow-Corning Corp.); and Fransol (Fransil Co.).

Further, from the viewpoints of aggregation characteristics and charging characteristics among the magnetic toner particles, and embedding due to endurance, the second external additive is favorably 0.1 parts by mass or more and 1.0 parts by mass or less, to the magnetic toner particles of 100 parts by mass, more favorably 0.5 parts by mass or more and 0.8 parts by mass or less.

Further, the toner favorably contains the second external additive of 10% by mass or more and 50% by mass or less, based on the content of the first external additive. The toner can obtain favorable characteristics regarding the initial fluidity, the charging characteristics, and easy loosening by the agitating blade of when rebooted after the printer is stopped during endurance as long as satisfying the above relationships.

Another external additive may be added to the toner of an exemplary embodiment of the present invention, as necessary.

Examples of the another external additive include: a charge adjuvant, a conductivity imparting agent, a fluidity imparting agent, a caking inhibitor, a release agent at the time of fixing a thermal roller, a lubricant, and resin fine particles and inorganic fine particles serving as an abrasive.

Examples of the lubricant include polyethylene fluoride powder, zinc stearate powder, and polyvinylidene fluoride powder. Among them, the polyvinylidene fluoride powder is favorable.

Examples of the abrasive include cerium oxide powder, silicon carbide powder, and strontium tinatate powder.

Further, the magnetic toner particles used in an exemplary embodiment of the present invention favorably have average circularity of 0.930 or more and 0.960 or less, in terms of establishment of both of isolation of the external additive from the magnetic toner surface, and easy loosening by the agitating blade at reboot after the developing unit is left for a long period of time.

Further, the magnetic toner particles of an exemplary embodiment of the present invention favorably have average surface roughness of the magnetic toner particles of 10.0 nm or more and 25.0 nm or less, in the viewpoint of controlling of adhering strength of the first external additive and uniformity of an external addition state. The average surface roughness of the magnetic toner particles represents smoothness of each magnetic toner particle surface.

### <Binder Resin>

As the binder resin contained in the magnetic toner particles, not especially limited to, but a polyester resin, a vinyl resin, an epoxy resin, or a polyurethane resin can be used.

### <Magnetic Material>

In an exemplary embodiment of the present invention, examples of the magnetic material contained in the magnetic toner include: iron oxides, such as magnetite, hematite, and ferrite; metals, such as iron, cobalt, and nickel; alloys of the aforementioned metals and metals, such as aluminum, cobalt, copper, lead, magnesium, tin, zinc, antimony, bismuth, calcium, manganese, titanium, tungsten, and vanadium; and a mixture thereof.

These magnetic materials favorably have the number average particle diameter of 2.0 to μm or less, favorably 0.05 μm or more and 0.5 μm or less. The amount to be contained in the toner is favorably 40 parts by mass or more and 90 parts by mass or less, to the binder resin 100 parts by mass.

### <Wax>

The magnetic toner of an exemplary embodiment of the present invention may contain a wax.

The wax used in an exemplary embodiment of the present invention includes the following examples. Examples of the wax include: aliphatic hydrocarbon wax such as low-molecular weight polyethylene, low-molecular weight polypropylene, polyolefin copolymer, polyolefin wax, microcrystalline wax, paraffin wax, and Fischer-Tropsch wax; oxides of aliphatic hydrocarbon wax such as oxide polyethylene wax or block copolymers thereof; plant wax such as candelilla wax, carnauba wax, haze wax, and jojoba wax; animal wax such as bees wax, lanoline, and spermaceti wax; mineral wax such as ozocerite, ceresin, and petrolatum; wax mainly containing aliphatic ester, such as montanic acid ester wax and caster wax; and wax in which part or whole of aliphatic ester is deoxidized, such as dioxidized carnauba wax. Further, the wax may be any of: saturated straight-chain fatty acids such as palmitic acid, stearic acid, montanic acid, and long-chain alkyl carboxylic acid having a long chain alkyl group; unsaturated fatty acids such as brassidic acid, eleostearic acid, and parinaric acid; saturated alcohols such as stearyl alcohol, eicosyl alcohol, behenyl alcohol, carnaubyl alcohol, ceryl alcohol, melissyl alcohol, and alkyl alcohol having a long-chain alkyl group; polyalcohols such as sorbitol; aliphatic amides such as linoleic acid amide, oleic acid amide, and lauric acid amide; saturated aliphatic acid bis-amides such as methylene bis-stearic acid amide, ethylenebis-caprinic acid amide, ethylenebis-lauric acid amide, and hexamethylene bis-stearic acid amide; unsaturated fatty acid amides such as ethylene bis-oleic acid amide, hexamethylene bis-oleic amide, N,N′-dioleyl adipic acid amide, and N,N′-dioleyl sebacic acid amide; aromatic bis-amides such as m-xylene bis-stearic acid amide and N,N′-distearyl isophthalic amide; fatty metallic salts such as calcium stearate, calcium laurate, zinc stearate, and magnesium stearate (typically referred to as a metallic soap); wax in which vinyl monomers such as styrene and acrylic acid are grafted in aliphatic hydrocarbon wax; partially esterified products of fatty acid such as behenylic acid monoglyceride and polyalcohol; and methyl ester compounds having hydroxyl groups which can be obtained by hydrogenation of a vegetable oil.

Moreover, these waxes, molecular weight distribution of which is sharpened using a pressing-sweating method, a solvent method, a recrystallization method, a vacuum distillation method, a supercritical gas extraction method, or a melt-crystallization method, and these waxes, from which low molecular weight solid fatty acid, low molecular weight solid alcohol, low molecular weight solid compound, and other impurities are removed, are also favorably used.

As specific examples of a wax usable as the release agent include: VISCOL (registered trademark) 330-P, 550-P, 660-P, TS-200 (available from Sanyo Chemical Industries, Ltd.); HIWAX 400P, 200P, 100P, 410P, 420P, 320P, 220P, 210P, 110P (available from Mitsui Chemicals, Inc.); SASOL H1, H2, C80, C105, C77 (available from Schumann Sasol Co.); HNP-1, HNP-3, HNP-9, HNP-10, HNP-11, HNP-12 (available from Nippon Seiro Co., Ltd.); UNILIN (registered trademark) 350, 425, 550, 700, UNICID (registered trademark) 350, 425, 550, 700 (available from Toyo-Petrolite Co., Ltd.); and japan wax, bees wax, rice wax, candelilla wax, and carnauba wax (available from CERARICA NODA Co., Ltd.).

### <Charge Control Agent>

In the magnetic toner used in an exemplary embodiment of the present invention, it is favorable to use a charge control agent by combining (internally adding) the charge control agent with (to) the magnetic toner particles or by mixing (externally adding) the charge control agent with (to) the magnetic toner particles so as to control a charge amount and charge amount distribution of the magnetic toner particles.

An example of a negative charge control agent for controlling the toner to have negative charge properties include: an organic metal complex and a chelate compound. Examples of the organic metal complex include: a monoazo metal complex, an acetylacetone metal complex, an aromatic hydroxy carboxylic acid metal complex, and an aromatic dicarboxylic acid metal complex.

Further, examples of the negative charge control agent include: aromatic hydroxy carboxylic acid, aromatic monocarboxylic acid, aromatic polycarboxylic acid, and their metal salts; and anhydrides of aromatic hydroxy carboxylic acid, aromatic monocarboxylic acid, and aromatic polycarboxylic acid.

Further, examples include ester compounds of aromatic hydroxy carboxylic acid, aromatic monocarboxylic acid, and aromatic polycarboxylic acid, and phenol derivatives, such as bisphenol.

Favorable examples of the negative charge agent for negative charging include: Spilon Black TRH, T-77, T-95 (available from Hodogaya Chemical Co., Ltd.); and BONTRON (registered trademark) S-34, S-44, S-54, E-84, E-88, E-89 (available from Orient Chemical Industries Ltd.).

These charge control agents can be used alone, or used as a combination of two or more types. Further, a charge control resin can be also used, and can be used together with the above charge control agents.

The charge control agents are favorably used in a fine particle manner. When these charge control agents are internally added to the magnetic toner particles, it is favorable to add the charge control agents of 0.1 parts by mass or more and 20.0 parts by mass or less, to the binder resin of 100.0 parts by mass, to the magnetic toner particles.

The magnetic toner particles used in an exemplary embodiment of the present invention may be manufactured by either a pulverization method or a polymerization method. However, manufacturing by the pulverization method is favorable in terms of shape control.

Further, a method for sufficiently mixing the above-described toner configuration materials by a mixer, such as a ball mill, then kneading the materials well using a heating and kneading machine, such as a heat roll, a kneader, or an extruder, performing pulverization and classification after performing coarse pulverization after cooling solidification, and performing surface modification of the magnetic toner particles using a surface modification device is more favorable.

Examples of the mixer include: Henschel mixer (manufactured by Mitsui Mining Co., Ltd.); Super mixer (manufactured by Kawata Mfg. Co., Ltd.); Ribocone (manufactured by Okawara Mfg. Co., Ltd.); Nauta mixer, Turbulizer, and Cyclomix (manufactured by Hosokawa Micron Corporation); Spiral pin mixer (manufactured by Pacific Machinery & Engineering Co., Ltd.); and Redige mixer (manufactured by Matsubo Corporation).

Examples of a pulverizer include: Counter jet mill, Micron jet, and Inomizer (manufactured by Hosokawa Micron Corporation); IDS type mill and PJM jet pulverizer (manufactured by Nippon Pneumatic Mfg. Co., Ltd.); Crossjet Mill (manufactured by Kurimoto, Ltd.); Ulmax (manufactured by Nisso Engineering Co., Ltd.); SK Jet-O-Mill (manufactured by Seisin Enterprise Co., Ltd.); Cliptron (manufactured by Kawasaki Heavy Industries, Ltd.); Turbo Mill (manufactured by Turbo Kogyo Co., Ltd.); and Super Rotor (manufactured by Nisshin Engineering Inc.).

Further, examples of the classifier include: Classiel, Micron Classifier, and Spedic Classifier (manufactured by Seisin Enterprises Co., Ltd.); Turbo Classifier (manufactured by Nisshin Engineering Co., Ltd.); Micron separator, Turboplex (ATP), and TSP Separator (manufactured by Hosokawa Micron Co., Ltd.); Elbow-Jet (manufactured by Nittetsu Mining Co., Ltd.); Dispersion Separator (manufactured by Japan Pneumatic Co., Ltd.); and YM Microcut (manufactured by Yasukawa Electric Co., Ltd.).

Examples of the surface modification device include: Faculty (manufactured by Hosokawa Micron Corporation), Mechano Fusion (manufactured by Hosokawa Micron Corporation), Nobilta (manufactured by Hosokawa Micron Corporation), Hybridizer (manufactured by Nara Machinery Co., Ltd.), Inomizer (manufactured by Hosokawa Micron Corporation), Theta Composer (manufactured by Tokuju Corporation), and Mechano Mill (manufactured by Okada Seiko Co., Ltd.).

Further, examples of a screening device for sifting coarse particles and the like include: Ultra Sonic (manufactured by Koei Sangyo Co., Ltd.); Resona Sieve and Gyro Sifter (manufactured by Tokuju Corporation); Vibrasonic System (manufactured by Dalton Corporation); Soniclean (manufactured by Sinto Kogyo Co., Ltd.); Turbo Screener (manufactured by Turbo Kogyo Co., Ltd.); Micro Sifter (manufactured by Makino Mfg. Co., Ltd.); and Circular Oscillation Sieve.

The magnetic toner particles of an exemplary embodiment of the present invention favorably have the weight average particle diameter (D4) of 2.5 μm or more and 10.0 μm or less. More favorably, 5.0 μm or more and 9.0 μm or less, and further more favorably, 6.0 μm or more and 8.0 μm or less.

Further, the above-described desired external additive is sufficiently mixed by a mixer such as a Henschel mixer, and the magnetic toner according to an exemplary embodiment of the present invention can be manufactured.

A method for measuring physical properties according to the magnetic toner of an exemplary embodiment of the present invention is as follows. Examples described below are based on this method.

### <Method for Measuring the Number Average Particle Diameter and the Shape Factor of the External Additive>

Measurement of the number average particle diameter of the external additive is performed using a scanning electron microscope “S-4800” (Product name; Hitachi, Ltd.). Toner to which the external additive is externally added is observed, long diameters of 100 primary particles of the external additive are randomly measured in a view magnified up to two hundred thousand times, and the number average particle diameter is obtained. The observation magnification is appropriately adjusted according to the size of the external additive.

The shape factors SF-1 and SF-2 of the external additive are calculated as follows by observing the toner to which the external additive is externally added using the scanning electron microscope(SEM) “S-4800” (manufactured by Hitachi, Ltd.).

The observation magnification is appropriately adjusted according to the magnitude of the external additive. The long diameter, the perimeter, and the area of 100 primary particles are calculated in a view magnified up to two hundred thousand times, using the image processing software “Image-Pro Plus5.1J” (manufactured by MediaCybernetics). The shape factors SF-1 and SF-2 of individual particles can be calculated by the following formulas, and average values of 100 particles are employed as the shape factors SF-1 and SF-2 of the external additive.

SF-1=(the long diameter of a particle)²/the area of a particle×100×π/4

SF-2=(The perimeter of a particle)²/the area of a particle×100/4π

### <Method for Measuring the Weight Average Particle Diameter (D4)>

The weight average particle diameter (D4) of the toner of an exemplary embodiment of the present invention is determined by performing a measurement with a high precision particle size distribution measurement apparatus “Coulter Counter, Multisizer 3” (trade mark, manufactured by Beckman Coulter, Inc.) based on the pore electric resistance method, equipped with a 100-μm aperture tube and an appended dedicated software “Beckman-Coulter Multisizer 3, Version 3.51” (produced by Beckman Coulter, Inc.) for setting the measurement conditions and analyzing the measured data, at an effective measurement channel number of 25,000, the measurement being followed by analysis of the measured data with the dedicated software to calculate the weight average particle diameter (D4).

As the electrolyte aqueous solution used for the measurement, a solution prepared by dissolving guaranteed grade sodium chloride in ion-exchanged water so as for the concentration of the solution to be approximately 1% by mass, such as “ISOTON II” (manufactured by Beckman-Coulter, Inc.) can be used.

Before performing the measurement and analysis, the setting of the dedicated software is made as follows.

In the “Screen for Altering Standard Operation Method (SOM)” of the dedicated software, the total count number of the control mode is set at 50,000 particles, the number of measurement runs is set at one, the Kd value is set at a value obtained by using the “10.0-μm standard particles” (manufactured by Beckman-Coulter, Inc.). By pushing the threshold value/noise level measurement button, the threshold value and the noise level are automatically set. The current is set at 1,600 μA, the gain is set at 2, the electrolyte solution is set at ISOTON II, and the flush of the aperture tube after measurement is marked.

In the “Screen for Setting Pulse to Particle Size Conversion” of the dedicated software, the bin interval is set at the logarithmic particle size, the particle size bin is set at the 256 particle size bin, and the particle size range is set at a range from 2 μm to 60 μm.

The specific measuring method is as follows.

(1) In a 250-ml round-bottom glass beaker for exclusive use for Multisizer 3, approximately 200 ml of the electrolyte aqueous solution is placed, the beaker is set on a sample stand, and the solution is stirred with a stirrer rod at 24 revolutions/second in a counterclockwise manner. With the function of “flush of aperture” of the analysis software, the dirt and the air bubbles inside the aperture tube are removed.

(2) In a 100-ml flat bottom glass beaker, approximately 30 ml of the electrolyte aqueous solution is placed, and in this beaker, as a dispersant, approximately 0.3 ml of a diluted solution prepared by diluting “Contaminon N” to 3-fold by mass with ion-exchanged water is additionally placed, (wherein “Contaminon N” is a 10% by mass aqueous solution of a neutral detergent having a pH of 7, for use in washing precision measurement instruments, and which is composed of a nonionic surface-active agent, an anionic surface-active agent, and an organic builder manufactured by Wako Pure Chemical Industries Ltd.).

(3) A predetermined amount of ion-exchanged water is placed in a water tank of an ultrasonic dispersion device “Ultrasonic Dispersion System Tetora 150” (manufactured by Nikkaki-Bios Co., Ltd.) having an electric output power of 120 W, equipped with two built-in oscillators of an oscillation frequency of 50 kHz with a phase shift of 180 degrees therebetween, and then approximately 2 ml of above-mentioned Contaminon N is placed in this water tank.

(4) The beaker in the above mentioned (2) is set in the beaker fixing hole of the ultrasonic dispersion device, and then the ultrasonic dispersion device is made to operate. Then, the height of the beaker is adjusted in such a way that the resonance state of the liquid surface of the electrolyte aqueous solution in the beaker comes to be maximum.

(5) Under the condition that the electrolyte aqueous solution in the beaker of the above-described (4) is being irradiated with ultrasonic wave, approximately 10 mg of the toner is added to and dispersed in the electrolyte aqueous solution, in a small amount at a time. Then, the solution continues to be subjected to an ultrasonic dispersion treatment further for 60 seconds. In performing the ultrasonic dispersion, the water temperature of the water tank is appropriately regulated to be 10° C. or higher and 40° C. or lower.

(6) The electrolyte aqueous solution described in (5) in which toner is dispersed is dropped into the round-bottom beaker described in the above-described (1) placed in the sample stand using a pipette so that the measured concentration becomes approximately 5%. Then, the measurement is performed until the number of the measured particles reaches 50,000.

(7) The measurement data are analyzed with the dedicated software attached to the apparatus to calculate the weight average particle diameter (D4). When the graph/% by volume is set in the dedicated software, an “average diameter” of the analysis/volume statistical value (arithmetic average) in the screen is the weight average particle diameter (D4).

### <Method for Measuring Toner Average Circularity>

The average circularity of the toner particles is measured with a flow type particle image analyzer “FPIA-3000 Model” (manufactured by Sysmex Corporation) on the basis of conditions of measurement and analysis made in operating corrections.

A specific measuring method is as follows: First, about 20 ml of ion-exchanged water, from which impurity solid matter and the like have been removed in advance, is put into a container made of glass. To this water, about 0.2 ml of a dilute solution is added as a dispersant, which has been prepared by diluting “CONTAMINON N” (an aqueous 10% by mass solution of a pH 7 neutral detergent for washing precision measuring instruments which is composed of a nonionic surface-active agent, an anionic surface-active agent and an organic builder and is manufactured by Wako Pure Chemical Industries, Ltd.) with ion-exchanged water to about 3-fold by mass. Further, about 0.02 g of a measuring sample is added, followed by dispersion treatment for 2 minutes by means of an ultrasonic dispersion machine to prepare a liquid dispersion for measurement. In that course, the dispersion system is appropriately cooled so that the temperature of the liquid dispersion becomes 10° C. or more and 40° C. or less. As the ultrasonic dispersion machine, a desk-top ultrasonic washer dispersion machine of kHz in oscillation frequency and 150 W in electric output (for example, “VS-150”, manufactured by Velvo-Clear Co.) is used. Into its water tank, a predetermined amount of ion-exchanged water is put, and about 2 ml of the above CONTAMINON N is added to the water tank.

In the measurement, the flow type particle image analyzer is used, having “UPlanApro” (magnifications: 10 times, numerical aperture: 0.40) as a standard objective lens, and Particle Sheath “PSE-900A” (manufactured by Sysmex Corporation) is used as a sheath solution. The liquid dispersion having been adjusted according to the above procedure is introduced into the flow type particle image analyzer, where 3,000 toner particles are measured in an HPF measuring mode and in a total count mode. Then, the binary-coded threshold value at the time of particle analysis is set to 85%, the particle diameters to be analyzed are limited to circle-equivalent diameters of 2.954 μm or more and less than 39.69 μm, and the average circularity of toner particles is obtained.

In measuring the circularity, before the measurement is started, autofocus control is performed using standard latex particles (for example, “RESEARCH AND TEST PARTICLES Latex Microsphere Suspensions 5200A”, manufactured by Duke Scientific Corporation, diluted with ion-exchanged water). Thereafter, the autofocus control may favorably be performed at intervals of 2 hours after the measurement has been started.

In the examples of the present application, a flow type particle image analyzer was used on which correction was operated by Sysmex Corporation and for which a correction certificate issued by Sysmex Corporation was granted. Measurement was performed on the measurement and analysis conditions set when the correction certificate was received, except that the particle diameters to be analyzed were limited to the circle-equivalent diameter of 2.954 μm or more and less than 39.69 μm.

### <Measurement of Average Surface Roughness of Magnetic Toner Particles>

In an exemplary embodiment of the present invention, the average surface roughness of the magnetic toner particles is measured using a scanning probe microscope. An example of the measuring method is illustrated as follows.

Probe station: SPI3800N (manufactured by Seiko Instruments Co., Ltd.)
Measuring unit: SPA400
Measuring mode: DFM (resonance mode) configuration image

### Cantilever: SI-DF40P

Resolving degree: X data number 256
Y data number 128

In an exemplary embodiment of the present invention, a 1 μm square area of the surface of the magnetic toner particles is measured. The area to be measured is a 1 μm square area of a central part of the magnetic toner particles measured by the scanning probe microscope. As the magnetic toner particles to be measured, the magnetic toner particles equal to the weight average particle diameter (D4) measured by the Coulter Counter method are randomly selected and measured. The measured data is subjected to the secondary correction. 5 or more different magnetic toner particles are measured, an average value of the obtained data is calculated, and the calculated value is employed as the average surface roughness of the magnetic toner particles.

In the magnetic toner in which the external additive is externally added to the magnetic toner particles, when the surfaces of the magnetic toner particles are measured using a scanning probe microscope, the external additive needs to be removed. An example of a specific method is as follows:

(1) 45 mg of the magnetic toner is put in a sample bottle, and 10 ml of methanol is added.

(2) The sample is dispersed for one minute with a ultrasonic washing machine, and the external additive is separated.

(3) The sample is sucked and filtered (10 μm membrane filter), and the magnetic toner particles and the external additive are separated.

Alternatively, a magnet is placed to the bottom of the sample bottle. The magnetic toner particles are fixed, and only a supernatant liquid may be separated.

(4) The above steps (2) and (3) are performed three times in total, and the obtained magnetic toner particles are sufficiently dried at a room temperature with a vacuum dryer.

The magnetic toner particles from which the external additive has been removed are observed with a scanning electron microscope. After the fact that the external additive has gone is confirmed, the surface of the magnetic toner particles can be observed with the scanning probe microscope. When the external additive has not been sufficiently removed, the steps (2) and (3) are repeatedly performed until the external additive is sufficiently removed. Then, the observation of the surface of the magnetic toner particles with the scanning probe microscope is performed.

An example of another method for removing the external additive instead of (2) and (3) includes a method for dissolving the external additive with an alkali. As the alkali, an aqueous sodium hydroxide solution is favorable.

The following terms will be described.

Average Surface Roughness (Ra)

This is 3-dimensional extension of the center line average roughness (Ra) defined in JIS B0601 in order to apply to the measuring surface. It is an average value of an absolute value of deviation from a standard surface to a designated surface, which is represented by the following formula:

$$Ra = \frac{1}{{S}_{0}} {\int }_{{T}_{B}}^{{Y}_{T}} {\int }_{{X}_{L}}^{{X}_{R}} \vert F ( X , Y ) - {Z}_{0} \vert d X d Y \qquad [ Formula 1 ]$$

F (X, Y): Surface indicated by all measurement data
S₀: Area when assumed that the designated surface is ideally flat
Z₀: Mean value of Z data within the designated surface
The designated surface in an exemplary embodiment of the present invention means the area to be measured of a 1 μm square.

### <Method for Measuring a Silica Covering Rate>

First, the amount of Silicon (hereinafter, abbreviated as Si) derived from silica and existing on the toner particle surface is measured by X-ray photoelectron spectroscopic analysis (ESCA).

The ESCA instrument and measurement conditions are as follows.

Instrument used: Quantum 2000 manufactured by ULVAC-PHI, Incorporated
Analysis method: narrow analysis

### Measurement Conditions:

X-ray source: Al-Kα
X-ray conditions: Beam diameter 100 μm, 25 W, 15 kV
Photoelectron incidence angle: 45°
Pass energy: 58.70 eV
Measurement range: φ 100 μm

In the analysis method, first, a peak derived from the C—C bond of carbon 1s orbit is corrected to 285 eV. Following that, the ratio “A (atomic %)” of Si derived from silica to the total amount of the configuration elements in the toner is calculated from a peak area derived from the silicon 2p orbit in which a peak top is detected at 100 eV or more and 105 eV or less, using the relative sensitivity factor provided by ULVAC-PHI, Incorporated.

Next, by a method similar to the above-described method, the Si amount of silica alone, which is applied to the magnetic toner, is measured, and a ratio “B (atomic %) of Si derived from silica to the total amount of the configuration elements in the silica alone is obtained. This ratio B (atomic %) is regarded as a value of the covering rate 100%.

At this time, the silica covering rate in an exemplary embodiment of the present invention is calculated by:

Silica covering rate (%)=Ratio A/Ratio B×100

When both of the first and second external additives are silica, the Si amounts of the external additive alone of the first and second external additives are the same, and are measured by the above method.

On the other hand, when an element other than silica is used as the first external additive, the Si amounts of the external additive alone of the first and second external additives are different, and thus calculation is performed using the following method.

A ratio A₁ of Si in the magnetic toner to which only the first external additive is added is measured. Similarly, a ratio A₂ of Si in the magnetic toner to which only the second external additive is added is measured. The silica covering rate of this case is calculated by the following formula, using the ratio “B (atomic %)” of Si:

Silica covering rate (%)=(Ratio A₁/Ratio B+Ratio A₂/Ratio B)×100

### <Method for Measuring FT-4 and Method for Calculating Total Energy>

In the exemplary embodiment of the present invention, the energy when the toner power layer in a compressed state is loosened is measured using a powder flowability analyzer equipped with a rotary propeller-type blade (FT-4, manufactured by Freeman Technology).

Specifically, measurement is carried out by the following operations. In all the operations, the propeller type blade used is a 23.5 mm diameter blade for use in FT-4 measurement (see FIG. 6A). An axis of rotation exists in the normal direction at the center of the 23.5 mm×6.5 mm blade plate. The blade plate is smoothly twisted counterclockwise by 70° at both outermost edge portions thereof (the portions 12 mm from the axis of rotation), and by 35° at portions 6 mm from the axis of rotation (see FIG. 6B). The blade material is SUS stainless steel.

(1) First, 23 g of toner that had been left in a 23° C., 60% environment for 3 days was placed in a specialized vessel for use in FT-4 measurement (a 25 mm diameter, 25 mL volume split vessel (model No.: C4031), height from a vessel bottom to a split portion is about 51 mm, hereinafter, may be simply referred to as “vessel”).

(2) Conditioning Operation

(a) The propeller blade is rotated clockwise with respect to the surface of the magnetic toner powder layer (in the direction where blade rotation does not push in the magnetic toner powder layer) with a blade peripheral speed (peripheral speed at the outermost edge portion of the blade) of 60 mm/sec. The propeller blade is advanced into a position of 10 mm from the bottom surface of the toner powder layer from the powder layer surface where an advancing speed in the vertical direction to the magnetic toner powder layer is a speed in which an angle made by an orbit traced by the outermost edge portion of the blade during movement and the powder layer surface (hereinafter, may be referred to as “blade made angle”) is 5 degrees.

(b) Following that, the propeller blade is, while being rotated in the clockwise direction with respect to the powder layer surface at the blade peripheral speed of 60 mm/sec, advanced into a position of 1 mm from the bottom surface of the magnetic powder layer, where the advancing speed in the vertical direction to the powder layer is a speed in which the made angle becomes 2 degrees.

(c) Following that, the propeller type blade, while being rotated in the counterclockwise direction with respect to the toner powder layer surface at the blade peripheral speed of 60 mm/sec, is moved to a position of 70 mm from the bottom surface of the powder layer and is drawn out of the toner powder layer, at a withdrawal speed with the made angle of 5 degrees.

(d) Once withdrawal is completed, the blade is alternately rotated a little in the clockwise and counterclockwise directions so as to knock off the toner attached to the blade.

(e) Following that, the operations of (a) to (d) are repeated, and the conditioning operation is performed five times in total.

(3) Compressing Operation of the Magnetic Toner

A compression test piston (the diameter 24 mm, the height 20 mm, and a lower portion is meshed) is mounted instead of the propeller type blade, and compression of the powder layer is performed with 5.8 kPa for 60 seconds.

(4) Splitting Operation

The toner powder layer is scraped flat at the split portion of the specialized vessel for FT-4 measurement, and the toner at the top of the toner powder layer is removed, so that a toner powder layer having the same volume (25 mL) is formed.

(5) Measuring Operations

The propeller type blade is rotated clockwise with respect to the surface of the magnetic toner powder layer with the blade peripheral speed of 100 mm/sec. The advancing speed in the vertical direction to the magnetic toner powder layer is a speed in which the angle made by an orbit traced by the outermost edge portion of the blade during movement and the powder layer surface (hereinafter, may be referred to as “blade orbit angle”) is 5 degrees. Under this condition, the propeller type blade is advanced to a position of 10 mm from the bottom surface of the magnetic powder layer, using a position of 70 mm from the bottom surface of the magnetic toner powder layer as a measurement starting point. In addition, a range of about first 20 mm after the measurement is started from the position of 70 mm from the bottom surface is a range in which the magnetic toner layer does not exist, and is a region from which the blade is approaching the magnetic toner layer while performing idle rotation.

In the above measuring operation, a value calculated from the rotation torque and the vertical load obtained when the propeller type blade is advanced from the measurement starting point to a position that is 10 mm from the bottom surface is the total energy defined in an exemplary embodiment of the present invention.

Basic configurations and characteristics of exemplary embodiments of the present invention have been described above. The exemplary embodiments of the present invention will be specifically described with reference to the examples below. However, the exemplary embodiments of the present invention are not limited by the examples. The unit in the examples is parts by mass.

### <Manufacturing Example of the External Additive A>

An oxygen gas was supplied to a burner, the ignition burner was ignited, a hydrogen gas was then supplied to the burner and a flame was formed. Silicon tetrachloride that is the material was put into the flame and was gasified. A flame hydrolysis reaction was performed in a condition illustrated in Table 1, and generated silica powder was collected.

Thereafter, the obtained silica powder was transferred to an electric furnace, spread in a thin layer manner, subjected to heat processing at 700° C., and then sintered and aggregated.

Next, the hydrophobic processing was applied such that 10 parts by mass of hexamethyldisilazane was added to 100 parts by mass of the obtained silica fine particles as a surface treatment agent.

### <Manufacturing Examples of External Additives B to E>

First external additives B to D were obtained, similarly to the first external additive A, except that the silicon tetrachloride flow rate, the oxygen gas supply flow rate, the hydrogen gas supply flow rate, the silica concentration, and the retaining time were changed as illustrated in Table 1. The number average particle diameters and the shape factors of the external additives A to E are illustrated in Table 2.

TABLE 1
Manufacturing conditions of nonspherical dry silica as the external
additive used in an exemplary embodiment of the present invention

| | | Nonspherical dry silica | | | | |
|---|---|---|---|---|---|---|
| | | A | B | C | D | E |
| Manufacturing conditions | Silicon tetrachloride | 100 | 120 | 100 | 100 | 100 |
| of nonspherical silica | flow rate (kg/h) | | | | | |
| | Oxygen gas supply | 30 | 30 | 25 | 50 | 30 |
| | flow rate (Nm³/h) | | | | | |
| | Hydrogen gas supply | 50 | 50 | 50 | 50 | 60 |
| | flow rate (Nm³/h) | | | | | |
| | Retaining time (sec) | 0.01 | 0.015 | 0.02 | 0.01 | 0.04 |
| | Heat processing in an | 700 | 700 | 700 | 700 | 700 |
| | electric furnace (° C.) | | | | | |

### <Manufacturing Example of an External Additive F>

As an external additive F having the physical properties of Table 2, an external additive manufactured according to Example 1 of WO 2013/063291 was prepared.

### <Manufacturing Example of an External Additive G>

An external additive G was obtained by a similar operation to the external additive A, except that the heat processing for sintering was not performed. The number average particle diameter and the shape factor are illustrated in Table 2.

### <Manufacturing Examples of External Additives H, I, and J>

External additives H, I, and J were obtained in such a manner that surfaces of silica fine particles obtained by a typical wet sol-gel method were subjected to hydrophobic processing with hexamethyldisilazane. The number average particle diameters and the shape factors are illustrated in Table 2.

### <External Additive K>

As an external additive K, commercially available strontium tinatate (manufactured by Fuji Titanium Industry Co., Ltd.) was used. The number average particle diameter and the shape factor are illustrated in Table 2.

### <External Additive L>

As an external additive L, silica obtained by a fumed method, in which a technical product is BET200 and the primary particle diameter is 13 nm, was used.

### <External Additive M>

As an external additive M, silica obtained by a fumed method, in which a technical product is BET300 and the primary particle diameter is 10 nm, was used.

TABLE 2

| | | Physical properties | | |
|---|---|---|---|---|
| | | of the external additive | | |
| | | of a toner surface | | |
| | | observed with a SEM | | |
| External | | enlarged photograph | | |
| additive | | Number average particle | | |
| No. | Type | diameter (nm) | SF-1 | SF-2 |
| A | Nonspherical silica | 132 | 189 | 218 |
| B | Nonspherical silica | 146 | 215 | 246 |
| C | Nonspherical silica | 185 | 206 | 244 |
| D | Nonspherical silica | 85 | 168 | 128 |
| E | Nonspherical silica | 172 | 251 | 274 |
| F | Resin composition- | 95 | 109 | 105 |
| | silica composite fine | | | |
| | particles | | | |
| G | Nonspherical silica | 71 | 130 | 148 |
| H | Spherical wet silica | 65 | 105 | 102 |
| I | Spherical wet silica | 110 | 108 | 103 |
| J | Spherical wet silica | 210 | 106 | 104 |
| K | Strontium titanate | 80 | 154 | 123 |
| L | Silica having a small | 13 | — | — |
| | particle diameter | | | |
| M | Silica having a small | 10 | — | — |
| | particle diameter | | | |

### <Manufacturing of the Magnetic Toner Particles 1>

| | |
|---|---|
| Polyester resin | 100 parts by mass |
| Magnetic iron oxide particles | 60 parts by mass |
| Polyethylene wax (PW2000, manufactured | 4 parts by mass |
| by Toyo-Petrolite Co., Ltd., and | |
| the melting point 120° C.) | |
| Charge control agent (T-77, manufactured | 2 parts by mass |
| by Hodogaya Chemical Co., Ltd.) | |

The above materials were preliminarily mixed using a Henschel mixer. After that, the mixture was melted and kneaded with a biaxial extruder heated to 110° C. The kneaded product was cooled and was then coarsely pulverized with a hammer mill, and a coarsely pulverized product of the toner was obtained. The obtained coarse pulverized product was finely pulverized by mechanical pulverization using a mechanical pulverizer Turbo mill (manufactured by Turbo Kogyo Co., Ltd., surfaces of a rotor and a stator were plated with a chromium alloy containing chromium carbide (plating thickness was 150 μm and surface hardness was HV1050)). In the obtained fine pulverized powder, fine particles and coarse particles were simultaneously classified and removed by means of a multi-division classifying apparatus utilizing Coanda effect (Elbow Jet Classifier manufactured by Nittetsu Mining Co., Ltd.). After the classification, treatment of the magnetic toner particle surface was performed using a surface modification device: Faculty F-600 (manufactured by Hosokawa Micron Corporation), and surface modification and fine particle removal were performed. The magnetic toner particles 1 having the weight average particle diameter (D4) of 7.2 μm, the average circularity of 0.944, and the average surface roughness (Ra) of 23.9 nm, as illustrated in Table 3, were obtained through the above process.

### <Manufacturing Example of Magnetic Toner Particles 2>

Magnetic toner particles 2 having the weight average particle diameter (D4) of 6.9 μm, the average circularity of 0.957, and the average surface roughness (Ra) of 10.6 nm were obtained, similarly to the manufacturing example of the magnetic toner particles 1, except that the rotary peripheral speed of a dispersion rotor of a surface modification device was raised.

### <Manufacturing Example of Magnetic Toner Particles 3>

Magnetic toner particles 3 having the weight average particle diameter (D4) of 7.0 μm, the average circularity of 0.937, and the average surface roughness (Ra) of 31.5 nm were obtained, similarly to the magnetic toner particles 1, except that a jet stream pulverizer was used without using a mechanical pulverizer.

### <Manufacturing Example of Magnetic Toner Particles 4>

Magnetic toner particles 4 having the weight average particle diameter (D4) of 7.2 μm, the average circularity of 0.925, and the average surface roughness (Ra) of 51.2 nm were obtained, similarly to the manufacturing example of the magnetic toner particles 1, except that the surface modification using a surface modification device was not performed.

### <Manufacturing Method for Magnetic Toner Particles 5>

450 parts by mass of an aqueous 0.1 mol/L-Na₃PO₄ solution was introduced into 720 parts by mass of ion-exchanged water, and the solution was heated to the temperature of 60° C. Thereafter, 67.7 parts by mass of an aqueous 1.0 mol/L-CaCl₂ solution was added thereto to obtain an aqueous medium containing a dispersion stabilizer (Ca₃ (PO₄)₂).

| | |
|---|---|
| Styrene | 74.00 parts by mass |
| n-Butyl acrylate | 26.00 parts by mass |
| Divinylbenzene | 0.52 parts by mass |
| Iron complex of monoazo dye (T-77, | 1.00 parts by mass |
| Hodogaya Chemical Co., Ltd.) | |
| Hydrophobic processed magnetic material | 90.00 parts by mass |
| Amorphous Polyester | 3.00 parts by mass |

(Saturated polyester resin obtained by the condensation reaction between an ethylene oxide adduct of bisphenol A and terephthalic acid, Mn=5,000, the acid value=12 mg KOH/g, and Tg=68° C.)

The above-described component was uniformly dispersed and mixed with an attritor (manufactured by Mitsui Miike Engineering Corp.) to yield a monomer composition. The monomer composition was warmed to 60° C., 15.0 parts by mass of a paraffin wax (the heat absorption peak top temperature: 77.2° C.) was mixed with and dissolved in the monomer composition, and then 4.5 parts by mass of a polymerization initiator 2,2′-Azobis (2,4-dimethylvaleronitrile) was dissolved in the mixture.

The monomer composition was introduced into the above-described aqueous medium, and granulation was carried out by stirring the mixture for 15 minutes at 12,000 rpm with a Clearmix (M Technique Co., Ltd.) at 60° C. under an N₂ atmosphere. Then, while being stirred with a paddle agitating stirring blade, the mixture was increased in temperature to 70° C. at a speed of 0.5° C./minute, and a reaction was run for 5 hours at 70° C. Following that, the temperature was raised to 90° C., and was held for 2 hours. After completion of the reaction, the suspension was cooled, hydrochloric acid was added and the Ca₃(PO₄)₂ was dissolved, and filtration, washing with water, and drying were performed, and the magnetic toner particles 5 having the weight average diameter (D4) of 8.0 μm, the average circularity of 0.979, and the average surface roughness (Ra) of 2.8 nm was obtained, as illustrated in Table 3.

TABLE 3
Physical properties of magnetic toner particles

| | Magnetic toner particles | | | | |
|---|---|---|---|---|---|
| | (1) | (2) | (3) | (4) | (5) |
| Weight average particle | 7.2 | 6.9 | 6.8 | 7.1 | 8.0 |
| diameter (D4); μm | | | | | |
| Average circularity; — | 0.944 | 0.957 | 0.937 | 0.925 | 0.979 |
| Average surface roughness | 23.9 | 10.6 | 31.5 | 51.2 | 2.8 |
| (Ra); nm | | | | | |

### Example 1

1.8 parts by mass of the external additive A as the first external additive and 0.5 parts by mass of the external additive L as the second external additive were externally mixed to 100 parts by mass of the magnetic toner particles 1 with a Henschel mixer, the mixture was sieved with a mesh with an aperture of 100 μm, and the magnetic toner 1 having negative friction charting characteristics was obtained. The physical properties of the obtained magnetic toner 1 are illustrated in Table 4. Evaluation below was performed using the obtained toner.

### [Evaluation]

HP LaserJet Enterprise600 M603dn was modified to have the process speed of 400 mm/s and was used, in consideration of further realization of a higher speed and longer lifetime of printers.

982 g of the magnetic toner 1 was filled in a predetermined process cartridge. An image output test was performed in a mode set so that a next job is started after the machine is once stopped between jobs where two sheets of vertical line pattern with the printing ratio of 2% is one job. In addition, as the evaluation environment of image output test, a normal temperature and normal humidity environment (23° C., 60% RH) was employed.

Solid Black Image Density

After outputting 100 sheets, and after outputting 50,000 sheets, charts in which a solid black image portion is formed on the entire printing paper are output one by one, and the reflection density was measured at five points with a Macbeth Densitometer (manufactured by Macbeth Co.), which is a reflection densitometer using an SPI filter, and an average value thereof was obtained. A larger numerical value indicates better developability. Evaluation results are illustrated in Table 5. The evaluation criteria are as follows:

A: Image density is 1.45 or more

B: Image density is 1.40 or more and less than 1.45

C: Image density is 1.30 or more and less than 1.40 D: Image density is less than 1.30

Uniformity in a Solid Black Portion (Solid Black Density Nonuniformity)

After outputting 25,000 sheets, the power supply of the image forming apparatus was turned off at a normal temperature and normal humidity environment (23° C., 60% RH), and the image forming apparatus was left for one week. Then, the image forming apparatus was started again, one sheet of chart in which a solid black image portion is formed on the entire printing paper was output, and the reflection density was measured at five points with a Macbeth Densitometer (manufactured by Macbeth Co.), which is a reflection densitometer using an SPI filter. An average value thereof was evaluated with the above criteria, and a difference between a maximum value and a minimum value in the measurement values of the five points was obtained. The difference was evaluated in the following criteria. Evaluation results are illustrated in Table 5.

A: 0.00 or more and less than 0.10

B: 0.10 or more and less than 0.15

C: 0.15 or more

White Streak in the Solid Black Portion (Solid Black White Streak)

After outputting 25,000 sheets, the power supply of the image forming apparatus was turned off at a normal temperature and normal humidity environment (23° C., 60% RH), and the image forming apparatus was left for one week. Then, the image forming apparatus was started again, one sheet of chart in which a solid black image portion is formed on the entire printing paper was output, and evaluation was made with the following criteria. Evaluation results are illustrated in Table 5.

A: No white streak vertical line is seen.

B: One or two white streak vertical lines are slightly seen.

C: A clear white streak vertical line is seen, or three or more vertical lines are slightly seen.

Charging Member Contamination

After outputting 50,000 sheets, the charging member in the developing unit was collected, whether dirt derived from the external additive is seen was checked with eyes, and evaluation was made with the following criteria. Evaluation results are illustrated in Table 5.

A: No white dirt is seen.

B: Some white dirt is slightly seen.

C: White dirt stands out.

### Examples 2 to 14 and Comparative Examples 1 to 11

Magnetic toners 2 to 25 were obtained similarly to Example 1, except that formulation was changed to that illustrated in Table 4. Physical properties of the obtained magnetic toners are illustrated in Table 4.

Further, evaluation similar to Example 1 was performed using the obtained magnetic toners 2 to 25. Evaluation results are illustrated in Table 5.

TABLE 4
Configurations and physical properties of magnetic toners
Magnetic toner

| | Magnetic toner | | First external additive | | | | | Second external additive | | | | | |
|---|---|---|---|---|---|---|---|---|---|---|---|---|---|
| | particles | | | | Number aver- | | | | | Number aver- | | Covering | Total |
| | | (parts | | A (parts | age particle | | | | B (parts | age particle | (B/A) × | rate by | energy |
| | Type | by mass) | Type | by mass) | diameter (nm) | SF-1 | SF-2 | Type | by mass) | diameter (nm) | 100 (%) | silica (%) | (mJ) |
| Magnetic | 1 | 100 | A | 1.8 | 132 | 189 | 218 | L | 0.5 | 13 | 28 | 58.1 | 118.0 |
| toner 1 | | | | | | | | | | | | | |
| Magnetic | 3 | 100 | A | 1.8 | 131 | 190 | 217 | L | 0.5 | 12 | 28 | 53.5 | 107.0 |
| toner 2 | | | | | | | | | | | | | |
| Magnetic | 1 | 100 | A | 1.8 | 132 | 189 | 217 | L | 0.8 | 11 | 44 | 63.5 | 136.3 |
| toner 3 | | | | | | | | | | | | | |
| Magnetic | 1 | 100 | A | 1.8 | 131 | 188 | 217 | L | 0.3 | 13 | 17 | 52.1 | 99.7 |
| toner 4 | | | | | | | | | | | | | |
| Magnetic | 1 | 100 | A | 3.0 | 132 | 189 | 218 | L | 0.5 | 14 | 17 | 67.4 | 136.0 |
| toner 5 | | | | | | | | | | | | | |
| Magnetic | 1 | 100 | A | 1.2 | 133 | 190 | 219 | L | 0.1 | 12 | 8 | 47.2 | 98.7 |
| toner 6 | | | | | | | | | | | | | |
| Magnetic | 3 | 100 | A | 1.2 | 131 | 189 | 218 | L | 0.1 | 13 | 8 | 40.4 | 89.9 |
| toner 7 | | | | | | | | | | | | | |
| Magnetic | 1 | 100 | B | 1.8 | 146 | 215 | 246 | L | 0.5 | 12 | 28 | 54.5 | 114.0 |
| toner 8 | | | | | | | | | | | | | |
| Magnetic | 1 | 100 | F | 1.1 | 106 | 110 | 105 | L | 0.5 | 14 | 45 | 61.0 | 129.0 |
| toner 9 | | | | | | | | | | | | | |
| Magnetic | 1 | 100 | D | 1.8 | 85 | 168 | 128 | L | 0.2 | 13 | 11 | 58.0 | 112.0 |
| toner 10 | | | | | | | | | | | | | |
| Magnetic | 1 | 100 | C | 3.0 | 185 | 206 | 244 | L | 0.3 | 11 | 10 | 52.0 | 128.0 |
| toner 11 | | | | | | | | | | | | | |
| Magnetic | 5 | 100 | A | 1.6 | 130 | 190 | 218 | L | 0.15 | 12 | 9 | 55.0 | 82.7 |
| toner 12 | | | | | | | | | | | | | |
| Magnetic | 4 | 100 | A | 1.8 | 132 | 189 | 219 | L | 0.5 | 13 | 28 | 53.0 | 85.0 |
| toner 13 | | | | | | | | | | | | | |
| Magnetic | 5 | 100 | F | 1.1 | 105 | 109 | 104 | L | 0.2 | 12 | 18 | 55.0 | 103.0 |
| toner 14 | | | | | | | | | | | | | |
| Magnetic | 2 | 100 | A | 2.5 | 131 | 189 | 218 | — | — | 14 | — | 44.0 | 79.4 |
| toner 15 | | | | | | | | | | | | | |
| Magnetic | 2 | 100 | A | 0.75 | 132 | 190 | 219 | L | 1.0 | 11 | 133 | 61.5 | 152.0 |
| toner 16 | | | | | | | | | | | | | |
| Magnetic | 1 | 100 | G | 2.0 | 71 | 130 | 148 | L | 0.5 | 12 | 25 | 55.1 | 145.0 |
| toner 17 | | | | | | | | | | | | | |
| Magnetic | 2 | 100 | A | 3.0 | 131 | 188 | 218 | L | 1.0 | 12 | 33 | 75.2 | 98.0 |
| toner 18 | | | | | | | | | | | | | |
| Magnetic | 1 | 100 | A | 0.6 | 132 | 187 | 217 | L | 0.3 | 12 | 50 | 37.5 | 89.9 |
| toner 19 | | | | | | | | | | | | | |
| Magnetic | 1 | 100 | I | 1.8 | 110 | 108 | 103 | L | 0.2 | 13 | 11 | 55.1 | 111.0 |
| toner 20 | | | | | | | | | | | | | |
| Magnetic | 1 | 100 | E | 1.8 | 172 | 251 | 274 | L | 0.2 | 11 | 11 | 51.5 | 94.5 |
| toner 21 | | | | | | | | | | | | | |
| Magnetic | 5 | 100 | J | 1.8 | 210 | 106 | 104 | L | 0.3 | 14 | 17 | 48.5 | 100.0 |
| toner 22 | | | | | | | | | | | | | |
| Magnetic | 1 | 100 | H | 0.6 | 65 | 105 | 102 | L | 0.3 | 12 | 50 | 55.0 | 146.0 |
| toner 23 | | | | | | | | | | | | | |
| Magnetic | 1 | 100 | — | — | — | — | — | L | 1.3 | 13 | — | 61.7 | 154.0 |
| toner 24 | | | | | | | | | | | | | |
| Magnetic | 1 | 100 | K | 0.3 | 80 | 154 | 123 | M | 0.6 | 10 | 200 | 47.0 | 113.0 |
| toner 25 | | | | | | | | | | | | | |

TABLE 5
Evaluation results

| | | Image density | | | | | | | | | |
|---|---|---|---|---|---|---|---|---|---|---|---|
| | | Durability stability test | | | | One week left after endurance of 25,000 sheets | | | | | |
| | | | | | | | | Solid black | | | |
| | | 100 | | 50,000 | | First | | density | | Solid black | Charging member |
| | | sheets | | sheets | | sheet | | uniformity | | white streak | contamination |
| Example 1 | Magnetic | A | 1.47 | A | 1.46 | A | 1.46 | A | 0.06 | A | A |
| | toner 1 | | | | | | | | | | |
| Example 2 | Magnetic | A | 1.45 | B | 1.44 | B | 1.44 | A | 0.05 | A | A |
| | toner 2 | | | | | | | | | | |
| Example 3 | Magnetic | A | 1.49 | A | 1.45 | B | 1.44 | A | 0.10 | A | A |
| | toner 3 | | | | | | | | | | |
| Example 4 | Magnetic | B | 1.44 | B | 1.43 | B | 1.42 | A | 0.07 | A | A |
| | toner 4 | | | | | | | | | | |
| Example 5 | Magnetic | A | 1.50 | A | 1.48 | B | 1.44 | B | 0.11 | A | B |
| | toner 5 | | | | | | | | | | |
| Example 6 | Magnetic | B | 1.40 | C | 1.36 | C | 1.38 | B | 0.13 | A | A |
| | toner 6 | | | | | | | | | | |
| Example 7 | Magnetic | C | 1.38 | C | 1.32 | C | 1.35 | B | 0.13 | B | A |
| | toner 7 | | | | | | | | | | |
| Example 8 | Magnetic | A | 1.45 | B | 1.40 | B | 1.41 | A | 0.06 | A | A |
| | toner 8 | | | | | | | | | | |
| Example 9 | Magnetic | B | 1.42 | A | 1.46 | A | 1.45 | A | 0.09 | A | A |
| | toner 9 | | | | | | | | | | |
| Example 10 | Magnetic | A | 1.46 | C | 1.36 | C | 1.38 | B | 0.12 | B | A |
| | toner 10 | | | | | | | | | | |
| Example 11 | Magnetic | B | 1.40 | C | 1.30 | C | 1.31 | B | 0.10 | B | B |
| | toner 11 | | | | | | | | | | |
| Example 12 | Magnetic | A | 1.51 | C | 1.32 | C | 1.38 | A | 0.04 | B | B |
| | toner 12 | | | | | | | | | | |
| Example 13 | Magnetic | B | 1.41 | C | 1.30 | C | 1.35 | B | 0.14 | B | A |
| | toner 13 | | | | | | | | | | |
| Example 14 | Magnetic | B | 1.44 | B | 1.44 | B | 1.43 | A | 0.05 | A | B |
| | toner 14 | | | | | | | | | | |
| Comparative | Magnetic | C | 1.30 | D | 1.00 | D | 1.08 | C | 0.12 | C | B |
| Example 1 | toner 15 | | | | | | | | | | |
| Comparative | Magnetic | A | 1.46 | D | 1.29 | D | 1.29 | B | 0.16 | B | A |
| Example 2 | toner 16 | | | | | | | | | | |
| Comparative | Magnetic | A | 1.45 | D | 1.25 | D | 1.28 | C | 0.19 | B | C |
| Example 3 | toner 17 | | | | | | | | | | |
| Comparative | Magnetic | B | 1.43 | C | 1.38 | C | 1.30 | C | 0.20 | C | A |
| Example 4 | toner 18 | | | | | | | | | | |
| Comparative | Magnetic | C | 1.32 | D | 1.14 | D | 1.25 | C | 0.14 | C | B |
| Example 5 | toner 19 | | | | | | | | | | |
| Comparative | Magnetic | C | 1.38 | D | 1.11 | D | 1.20 | C | 0.21 | C | B |
| Example 6 | toner 20 | | | | | | | | | | |
| Comparative | Magnetic | C | 1.31 | D | 1.23 | D | 1.25 | B | 0.12 | B | C |
| Example 7 | toner 21 | | | | | | | | | | |
| Comparative | Magnetic | C | 1.39 | D | 1.05 | D | 1.08 | C | 0.11 | C | B |
| Example 8 | toner 22 | | | | | | | | | | |
| Comparative | Magnetic | B | 1.41 | D | 1.15 | D | 1.21 | C | 0.16 | C | A |
| Example 9 | toner 23 | | | | | | | | | | |
| Comparative | Magnetic | A | 1.49 | D | 1.10 | D | 1.15 | B | 0.17 | B | A |
| Example 10 | toner 24 | | | | | | | | | | |
| Comparative | Magnetic | A | 1.50 | D | 1.15 | C | 1.30 | B | 0.11 | B | A |
| Example 11 | toner 25 | | | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-159303 filed Jul. 31, 2013, which is hereby incorporated by reference herein in its entirety.

What is claimed is:

1. Magnetic toner comprising:
magnetic toner particles, each of which contains a binder resin and a magnetic material; and
a first external additive,
wherein the first external additive
1) is silica fine particles, or resin composition-silica composite particles,
2) has a number average particle diameter of 70 nm or more and 200 nm or less,
3) has a shape factor SF-1 of 100 or more and 250 or less, and
4) has a shape factor SF-2 of 105 or more and 250 or less, and
a covering rate of surfaces of the magnetic toner particles by silica measured by X-ray photoelectron spectroscopic analysis (ESCA) is 40.0% or more and 70.0% or less, and
total energy calculated from a rotation torque and a vertical load is 80.0 mJ or more and 140.0 mJ or less,
the rotation torque and the vertical load being obtained by the following steps of:
putting the magnetic toner in the measurement container;
compressing the magnetic toner put in the measurement container with a load of 5.8 kPa, and forming a compressed toner layer; and
advancing a propeller type blade into the compressed toner layer at a constant speed vertically with respect to the surface of the compressed toner layer, the propeller type blade rotating at an outermost edge's peripheral speed of 100 mm/sec.

2. The magnetic toner according to claim 1, wherein average circularity of the magnetic toner particles is 0.930 or more and 0.960 or less.

3. The magnetic toner according to claim 1, wherein the magnetic toner has silica having a number average particle diameter of a primary particle of 5 nm or more and 30 nm or less, as a second external additive, and
the content of the second external additive
i) is 0.1 parts by mass or more and 1.0 parts by mass or less, with respect to the magnetic toner particles of 100 parts by mass, and
ii) is 10% by mass or more and 50% by mass or less based on the content of the first external additive.

4. The magnetic toner according to claim 1, wherein the first external additive is silica composite particles in which a plurality of silica particles is coalesced.
